(19) United States
(12) Patent Application Publication
(10) Pub. No.: US 2004/0130437 A1
(43) Pub. Date: Jul. 8, 2004

(54) Locking system

(76) Inventor: Nicholas Paul Stevens, Ashbourne (GB)

Correspondence Address: JOHN V STEWART, 1308 HENRY BALCH DRIVE, ORLANDO, FL, 32810

(21) Appl. No.: 10/478,119

(22) PCT Filed: May 22, 2002
(86) PCT No.: PCT/GB02/02379

(30) Foreign Application Priority Data
Jun. 1, 2001 (GB) 0113291.9

(51) Int. Cl. H04Q 1/00

(52) U.S. Cl. 340/5.72; 340/5.26

(57) ABSTRACT

A locking system comprising a first subsystem (1) and a second subsystem (2). The first subsystem comprises a controller (26) for generating a sequence of lock codes, a memory (32) for storing the current lock code, and a display (60) for presenting the current lock code to a user. The second subsystem comprises a keypad (80) for permitting entry by a user of the lock code provided by the first subsystem, a real-time clock (72) for generating a first real-time clock signal, a processor (62) for applying a predetermined code-transforming algorithm to the received lock code and the first real-time clock signal to produce a release code, and a display (78) for presenting the release code to the user. The first subsystem further comprises a keypad (62) to permit entry by a user of the release code provided by the second subsystem, and a real-time clock (34) for generating a second real-time clock signal. The controller is operable to apply a predetermined correspondence-checking algorithm to the stored lock code, the received release code and the second real-time clock signal to produce a result, and to provide an unlocking signal in dependence upon the result.

### DESCRIPTION

This invention relates to locking systems.

The invention was originally conceived for providing locking systems for commercial vehicle fleets, but it has many other applications.

Consider the simple case where a fleet of one hundred vehicles are used to transport goods from a distribution depot to one hundred different destinations. The vehicle loads need to be locked to protect them from theft, and so one hundred locks are required, preferably not identical so that if one key is lost or stolen it is not necessary to replace all of the locks for full security. A person at each of the depot and the hundred destinations is trusted, but the vehicle drivers are not. The keys for the locks are therefore not given to the drivers, and the 101 trusted persons therefore each need to keep a bunch of one hundred keys. A total of 10,100 keys are therefore required. Each time a vehicle is to be unloaded, the trusted person needs to select the appropriate one of the one hundred keys on their bunch and then unlock the vehicle themself. The key cannot be given to the driver to unlock the load, for fear that the driver will make an impression of the key. If one of the bunches of keys is lost or stolen, it is necessary, for full security, to replace one hundred locks and 10,100 keys. It will be appreciated that, in this situation, conventional locks and keys cause problems.

A few electronic locking systems that use codes and code transforming algorithms have been proposed in the past that it might be possible to use to overcome or alleviate the above mentioned problems. The present invention provides such a system but with higher security than has hitherto been possible.

In accordance with one aspect of the present invention, there is provided a locking system comprising first and second subsystems. The first subsystem comprises: means (such as a first microcontroller) for generating a sequence of lock codes; means (such as an EEPROM) for storing the current lock code; and means (such as a display) for outputting the current lock code. The second subsystem comprises: means (such as a keypad) for receiving the lock code output by the first subsystem; means for generating a first real-time clock signal; means (such as a further microcontroller) for applying a predetermined code-transforming algorithm to the received lock code and the first real-time clock signal to produce a release code; and means (such as a further display) for outputting the release code. The first subsystem further comprises: means (such as a further keypad) for receiving the release code output by the second subsystem; means for generating a second real-time clock signal; means (such as the first-mentioned microcontroller) for applying a predetermined correspondence-checking algorithm to the stored lock code, the received release code and the second real-time clock signal to produce a result; and means for selectably providing an unlocking signal in dependence upon the result (for example to an electrically-actuated lock or to an immobilising circuit).

In the case where the invention is employed with a commercial vehicle fleet as exemplified above, such a first subsystem would be fitted to each of the vehicles, and such a second subsystem would be provided for each of the trusted persons. The 100 first subsystems can be identical, employing identical correspondence-checking algorithms, and the 101 second subsystems can be identical, employing identical code-transforming algorithms. When a load is to be unlocked, the displayed lock code is simply entered into the second subsystem to produce such a release code, and the release code is entered into the first subsystem to unlock the door. It does not matter that an untrustworthy person learns the release code, because although it will enable the lock to be unlocked this time, the chances of it enabling the lock to be unlocked a subsequent time can be made to be exceptionally small. It will be appreciated that, with the invention, the burden on the trusted persons is reduced, and furthermore that there are no physical keys to be lost or stolen. Moreover, in the event that one of the second subsystems were lost or stolen, it would be necessary to replace or update that part of each of the 100 first subsystems defining the correspondence-checking algorithm, but since these parts can be identical, that is not too onerous; it would also be necessary to replace or update that part of each of the 101 second subsystems defining the code-transforming algorithm, but, again, since these parts can be identical, that is also not too onerous. With the invention, the notion of replacing 100 non-identical locks and of replacing and cataloguing 10,100 keys becomes a thing of the past.

The use of the real-time clocks results in the release code for a particular lock code being valid for a restricted period of time so as to provide exceptionally high security.

For increased security, in the first subsystem, the code generating means is preferably operable to generate such lock codes randomly or pseudo-randomly.

Preferably, the generating means is operable to generate such a sequence of lock codes while the first subsystem is operating, by contrast to generating a lock code only when the first subsystem is started up.

Preferably, means is provided for detecting a particular event; the sequence generating means is operable to generate the next lock code in the sequence in response to detection of the particular event; and the storing means is operable to store said next lock code in place of the said current lock code in response to detection of the particular event.

Following the provision of the unlocking signal, the code generating means is preferably operable to generate the next lock code in the sequence.

In one embodiment, the first subsystem further comprises a sensor (such as a door sensor for a door to which is fitted an electrically-actuated lock responsive to the unlocking signal), and the code generating means is operable to generate the next lock code in the sequence in response to a signal from the sensor.

In another embodiment, the code generating means is operable to generate the next lock code in the sequence a predetermined time after the provision of the unlocking signal. Also, the means for providing the unlocking signal is preferably operable to provide that signal for a, or the, predetermined time. When the system is applied to a vehicle or machine that is enabled by the unlocking signal, for example a hire vehicle, the vehicle can therefore be immobilised after the predetermined period of time and cannot remobilised until the hirer has obtained (and, if required, paid for) the release code from the hire company.

The code-transforming algorithm and/or correspondence-checking algorithm preferably employ(s) information stored in a respective copy-resistant storage means in the respective subsystem.

The invention also extends to such a first subsystem per se and to such a second subsystem per se.

Specific embodiments of the present invention will now be described, purely by way of example, with reference to the accompanying drawings, in which:

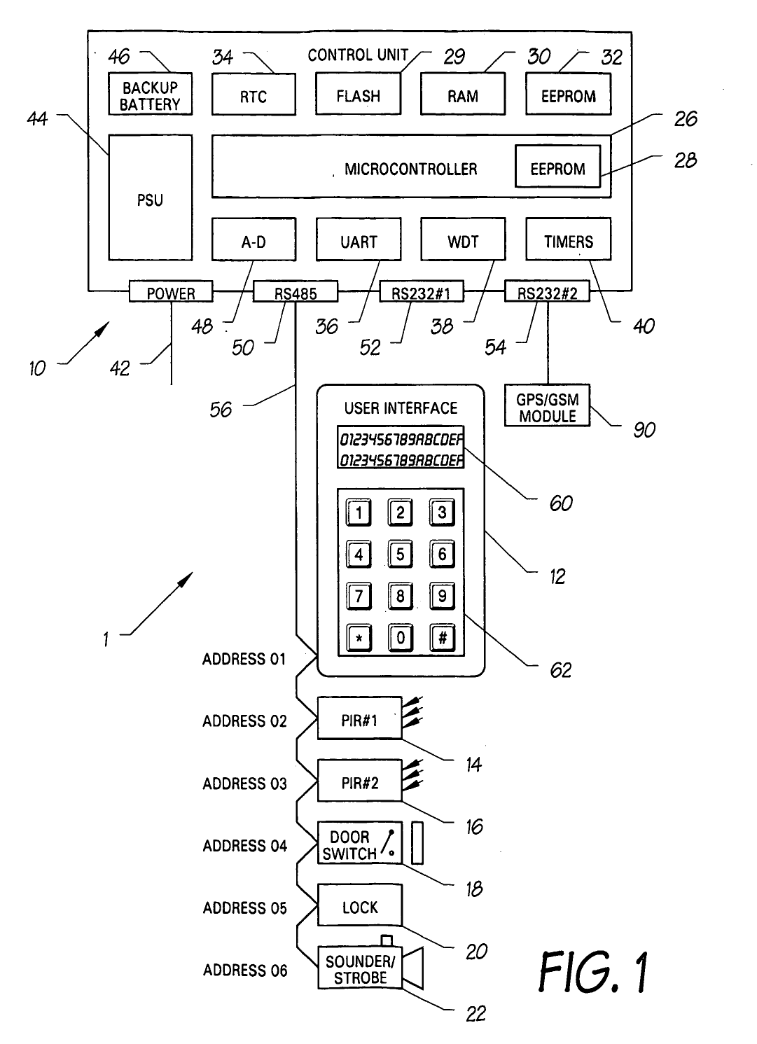

FIG. 1 is a block diagram of a first embodiment of the first subsystem;

FIG. 2 is a block diagram of an embodiment of the second subsystem; and

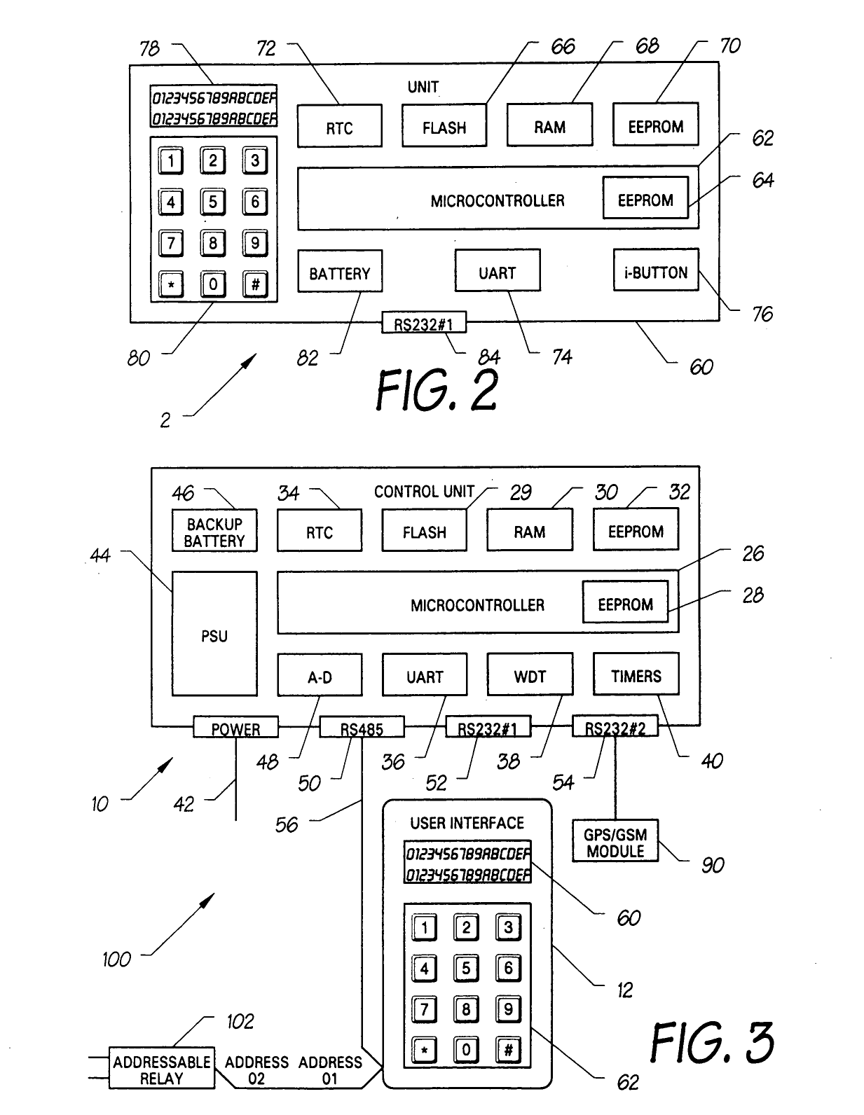

FIG. 3 is a block diagram of a second embodiment of the first subsystem.

Referring to FIG. 1, the first subsystem 1 comprises a control unit 10, a user interface 12, a number of sensors such as two PIR sensors 14,16 and a mechanically- and/or magnetically operated door switch 18, an electrically-actuated door lock 20 and an alarm sounder/strobe 22.

More specifically, the control unit 10 of the first sub-system 1 comprises a housing 24 containing a microcontroller 26 having on-chip EEPROM 28 storing the unit's algorithms. The microcontroller has associated program flash memory 29, working RAM 30 and EEPROM 32 for long-term data storage. The control unit 10 also includes a real time clock 34, a UART 36, a WDT 38 and timer circuits 40. The WDT 38 is a timer connected to the “reset” input of the microcontroller 26. When enabled, the WDT 38 starts counting down, and when the count reaches zero it resets the microcontroller 26. In operation, a reset command for the WDT 38 is embedded in the program code for the microcontroller 26 and is called more regularly than the expiry of the WDT 38 so that the WDT 38 does not normally reset the microcontroller 26. However, if the microcontroller 26 stalls, the WDT 38 does reset the microcontroller 26 so that it automatically recovers from the stall. The timer circuits 40 are used to interrupt operations of the microcontroller 26 to perform other timing functions as required.

The elements of the control unit 10 are powered by an external 12V or 24V supply 42 via a power supply circuit 44, and an internal backup battery 46 is included to maintain power to the real time clock 34 when the external supply 42 is removed. The external supply voltage and backup battery voltage are monitored by the microcontroller 26 via an analogue to digital converter 48. The control unit 10 communicates via an RS485 network port 50 and a pair of RS232 ports 52,54. The user interface 12, two PIR sensors 14,16, door switch 18, door lock 20 and alarm sounder/strobe 22 are connected by a network 56 to the RS485 port with each having its own preset network address, for example as shown in FIG. 1.

The user interface 12 comprises a housing 58 in which are mounted a two-line by sixteen-character backlit LCD display 60, a telephone-type keypad 62, and circuitry to enable the display 60 to display characters sent to the user interface 12 from the control unit 10 and to enable characters entered by the user via the keypad 62 to be sent to the control unit 10. The [symbol] key of the keypad 62 is used as a “delete” key, and the [symbol] key is used as an “enter” key.

In a typical installation of the first subsystem 1 on a lorry trailer having a pair of rear doors with a lock 20 of the slam type, the control unit 10 would be concealed inside the goods space of the trailer, the user interface 12 would be mounted on the outside of the trailer near the doors, the PIR sensors 14,16 would be mounted to the ceiling of the trailer so as to view substantially the whole of the goods space of the trailer, the door switch 18 would be mounted near the lock 20, and the sounder/strobe 22 would be externally mounted above the doors.

Referring to FIG. 2, the second subsystem or unit 2 comprises a hand-held housing 60 containing a microcontroller 62 having on-chip EEPROM 64 storing the unit's algorithms. The microcontroller has associated program flash memory 66, working RAM 68 and EEPROM 70 for long-term data storage. The unit 2 also includes a real time clock 72, a UART 74 and a security switch 76 such as a Dallas DS1990A i-Button switch, a two-line by sixteen-character backlit LCD display 78, a telephone-type keypad 80. Again, the [symbol] key of the keypad 80 is used as a “delete” key, and the [symbol] key is used as an “enter” key. The i-Button switch 76 and a corresponding i-Button each contain a 64-bit number that is guaranteed by the manufacturer to be unique. In operation the i-Button is momentarily pressed against the switch 76, and only if the 64-bit numbers correspond, the microcontroller is enabled.

The elements of the unit 2 are powered by an internal battery 82. The unit 2 can communicate electrically via an RS232 port 84, for example for re-programming, testing and setting of the real time clock 72.

The operation of the subsystems 1,2 shown in FIGS. 1 and 2 will now be described starting with a state in which:

the door switch 18 senses that the door is closed;

the lock 20 is locked;

the microcontroller 26 of the first unit 10 has generated a pseudo-random eight-digit number A₁ (the “seal number”) which is displayed on the LCD 60 (and which is also stored in the EEPROM 32 so that the number A₁ does not become lost in the event of a power failure) together with the time and a status message, e.g.

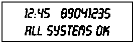

the second unit 2 is in a standby state; and

both real time clocks 34,72 are generally synchronised.

1. A person who wishes to unlock the door (the “door operator”) reads the seal number A₁ which is displayed by the display 60 and tells it to the person who has custody of the second subsystem 2 (the “custodian”), somebody who is entrusted to permit the door to be opened.

2. The custodian activates the second subsystem 2 using the i-Button as a result of which the microcontroller 62 causes the display 78 to display an initial message such as:

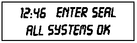

3. The custodian then enters the seal number A₁ they have been told into the keypad 80. As the digits of the seal number are entered, they are displayed on the display 78. An incorrectly entered digit can be deleted by pressing the [symbol] key, and once all eight digits have been entered, the custodian is required to press the [symbol] key.

4. The microcontroller 62 then reads the current time T₁ from the real time clock 72 and applies a predetermined first algorithm (which is stored in the on-chip EEPROM 64 of the microcontroller 62) to the seal number A₁ and the time T₁ in order to generate an eight-digit number B₁ (the “release number”) which the microprocessor 62 causes to be displayed on the display 78, e.g. as:

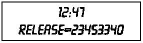

5. The custodian then reads the displayed release number B₁ and tells it to the door operator.

6. After a predetermined time, such as one minute, the second unit returns to its standby state.

7. The door operator enters the release number B₁ they have been told into the keypad 62 of the first subsystem 1. As the digits of the release number are entered, they are displayed on the display 60. An incorrectly entered digit can be deleted by pressing the [symbol] key, and once all eight digits have been entered, the door operator is required to press the [symbol] key.

8. The microcontroller 26 then reads the current time T₂ from the real time clock 34, reads the seal number A₁ stored in the EEPROM 32, and applies a predetermined second algorithm (which is stored in the on-chip EEPROM 28 of the microcontroller 26 and is a corollary of the first algorithm) to the seal number A₁, the time T₂ and the release number B₁ entered into the keypad 62 to determine whether the seal number A₁ and the release number B₁ correspond.

8.1. If they do not correspond:

8.1.1. The microcontroller 26 causes the display 60 to display an error message such as:

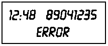

for a predetermined time, such as ten seconds, and does not supply current to the door lock 20 so that the door remains locked.

8.1.2. The microcontroller 26 then causes the display 60 to revert to displaying the seal number A₁ and then waits for a further release number to be entered into the keypad 62 in step “7” above.

8.2. On the other hand, if the seal number A₁, time T₂ and release number B₁ do correspond:

8.2.1. The microcontroller 26 causes the display 60 to display a message such as:

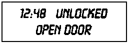

and supplies an unlocking signal to the door lock 20, so that the doors can be opened.

8.2.2. The microcontroller 26 then determines from the door switch 18 whether or not the door has been opened within a predetermined period of time, such as one minute.

8.2.2.1. If so:

8.2.2.1.1. The microcontroller 26 terminates the unlocking signal to the door lock 20 and causes the display 60 to display a message such as:

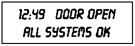

8.2.2.1.2. Then, once the door is subsequently closed, the microcontroller 26 detects this from the door switch 18 and, in response, generates a further pseudo-random eight-digit seal number A₂ which is displayed on the display 62 and which is also stored in the EEPROM 26 to replace the stored seal number A₁.

8.2.2.1.3. The first subsystem then reverts 1 to the initial state described above.

8.2.2.2. However, if the door has not been opened with the predetermined time:

8.2.2.2.1. The microcontroller 26 terminates the unlocking signal to the door lock 20 and displays a time-out message such as:

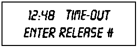

for a predetermined period of time, such as ten seconds.

8.2.2.2.2. The microcontroller 24 then causes the display 60 to revert to displaying the seal number A₁ and then waits for the release number to be re-entered into the keypad 62 in step “7” above.

As mentioned above in step “4” above, the microcontroller 62 applies a predetermined first algorithm, stored in the on-chip EEPROM 64, to the seal number Aᵢ and the time T₁ in order to generate the eight-digit release number Bi. In one embodiment, the time T₁ is an eight digit number in hhddmmyy format comprising the two digits hh of the hour of the day (24 hour clock), the two digits dd of the day of the month, the two digits mm of the month of the year and the two digits yy of the year in the twenty-first century. Therefore the time T₁ changes every hour. As an example, the first algorithm may apply a first one-way hash function f₁ to the seal number Aᵢ, add the result of that to the time T₁ and then apply a second one-way hash function f₂ to the result of that in order to produce the release number Bᵢ. In other words:

Bᵢ=f₂(T₁+f₁(A₁)).

It will therefore be appreciated that the valid release number Bᵢ for a particular seal number Aᵢ changes every hour. Also, as mentioned in step “8” above, microcontroller 26 applies a predetermined second algorithm, stored in the on-chip EEPROM 28, to the seal number Aᵢ, the time T₂ and the release number Bᵢ entered into the keypad 34 to determine whether the seal number Aᵢ and release number Bᵢ correspond. In the case of the particular first algorithm mentioned above, the corresponding test performed by the second algorithm may be represented as:

Bᵢ−f₂(T₂+f₁(Aᵢ))=0 ?

If so, the seal number Aᵢ and release number Bᵢ are taken to correspond. It will therefore be appreciated that, assuming the real time clocks 34,72 are synchronised, the release number Bᵢ will remain valid for unlocking the lock 20 only until the end of the hour of the day during which the release number Bᵢ was generated by the second unit 2.

Other more complex schemes may be employed to avoid the problem that, for example, a release number Bᵢ generated at one minute before the hour will be valid for only one minute. For instance, the times T₁,T₂ may be given a resolution of fifteen minutes rather than one hour, and the second algorithm may be modified so that it performs the test both for the current time T₂ and also for the current time less fifteen minutes. If either test is positive, then the seal number Aᵢ and release number Bᵢ are taken to correspond. It will appreciated that, in this way, a release number Bᵢ will remain valid for at least fifteen minutes, but not for longer than thirty minutes.

It will be noted from step “8.2.2.1.2” above that, when the doors are closed, the microcontroller 26 generates a further pseudo-random eight-digit seal number Aᵢ₊₁ which is displayed on the display 62 and which is also stored in the EEPROM 26 to replace the stored seal number Aᵢ. The random number generation may be carried out in any known way and may include a random number seed.

As mentioned above, the first and second algorithms are stored in the on-chip EEPROMs 64,28 of the microcontrollers 62,26. The microcontrollers 62,26 are configured to prevent the contents of the EEPROMs 64,28 being interrogated so that the algorithms can be kept secret and to prevent the algorithms being changed once they have initially been burned into the EEPROMs 64,28.

The first subsystem 1 may be provided with various auxiliary functions. For example:

The control unit 10 may be reprogrammed and tested and the real time clock 34 may be set using a computer connected to the RS232 port 52.

The microcontroller 26 may be programmed to store in the EEPROM 32 a timed log of events, such as power up, seal numbers generated, release numbers that are entered and the responses that are made, and the date and time on each occasion the door is closed. This log can then be subsequently downloaded via the RS232 port 52.

Rather than merely producing an error message in step “8.1.1” above, the microcontroller 26 may be programmed to activate the sounder/strobe 22 if a non-corresponding release number is entered in step “7” above. Alternatively, the microcontroller 26 may be programmed to set such an alarm condition if, say, two such non-corresponding release numbers are entered consecutively.

The first subsystem 1 may provide conventional burglar alarm functions by activating the sounder/strobe 22 in response to a signal from one of PIR sensors 14,16 or the door switch 18 unless the lock 20 is currently unlocked, or in response to activation of an anti-tamper circuit protecting all of the elements of the first subsystem 1. The alarm condition can then be reset after a predetermined time-out, or in response to entry of valid release number Bᵢ into the keypad 62.

The RS232 port 54 of the control unit 10 may be connected to one or more further modules 90, such as:

a GPS module that provides a geographical location signal to the microcontroller 26. In this case, the EEPROM 32 may be programmed via the RS232 port 52 so that the microcontroller 26 permits the lock 20 to be unlocked only at particular geographical locations. Also, the microcontroller 26 may be programmed to store in the EEPROM 32 a timed log of the current geographical locations at predetermined intervals and/or each time an event takes place; and/or

a GSM cellular phone module so that in the event of an alarm condition an SMS message may be sent to a predetermined destination number advising of the alarm condition that has occurred.

It will be appreciated that an organisation (or even a part of the same organisation) will require first units 10 that cannot be unlocked by another organisation's second unit 2. This is possible by providing different organisations with different algorithms stored in the on-chip EEPROMs 28,64. As an alternative, the EEPROMs 28,64 may store all of the algorithms (or keys to them) for all users, and a twelve-digit identity number C for a particular organisation relating to a particular one of the algorithms may be stored in the EEPROMs 32,70. In this case, the first algorithm may be represented, for example, as:

Bᵢ=f_{C}(T₁+f₁(Aᵢ))

and the second algorithm may be represented as:

Bᵢ−f_{C}(T₂+f₁(Aᵢ))=0 ?

where f_{C} is a particular one-way hash function dependent on the identity number C read from the EEPROM 28,64.

In the embodiment of the invention described above, the user interface 12 is connected to the control unit 10 by the cable of the RS485 network 56. Alternatively, the user interface 12 may be communicate with the control unit via an infra red link or a short-hop radio link, for example on the 418 MHz band.

Also, in the embodiment of the invention described above, the second unit 2 is a hand-held unit. Alternatively, it may be provided as a self-contained desk-top unit, as a computer peripheral for example communicating with a PC via its serial port, or as an element in a computer network. In the latter two cases, the PC or another PC on the network may be used for display and data entry purposes, rather than providing a display 78 and keypad 80 in the second unit 2.

In another development, instead of the seal number being displayed by the display 60 and entered using the keypad 80 and/or instead of the release number being displayed by the display 78 and entered using the keypad 62, the first and second subsystems 1,2 may communicate by other means such as an electrical, radio, or infra-red link, or the GSM module 90.

It will be appreciated that the embodiment of the invention described above has many other uses, for example in connection with strong room security, media stores, high value cash transfer containers, bonded stores, high value storage containers or fire proof safes.

A second embodiment of the invention will now be described. The second embodiment employs a first subsystem 100 as shown in FIG. 3, and a second subsystem as shown in and already described with reference to FIG. 2. The first subsystem 100 of FIG. 3 is similar to the first subsystem 1 of FIG. 1, except that: it is programmed to operate differently; the PIR sensors 14,16, door switch 18, lock 20 and sounder/strobe 22 are omitted from the RS485 network 56; and an addressable relay 102 is connected to the RS485 network. The contacts of the relay 102 are connected into the starter motor circuit (or other essential circuit) of a hire vehicle such as a hire car or plant so that the control unit 10 can selectably enable and disable the starter motor circuit.

The operation of the subsystems 2,100 shown in FIGS. 2 and 3 will now be described starting with a state in which:

the starter motor circuit is disabled by the relay 102 so that the vehicle is immobilised;

the microcontroller 26 of the first unit 10 has generated a pseudo-random eight-digit number A₁ (the “seal number”) which is displayed on the LCD 60 (and which is also stored in the EEPROM 32 so that the number A₁ does not become lost in the event of a power failure) together with the time and a predetermined telephone number that has been read from the EEPROM 70 (the telephone number is that of the hire company), e.g.

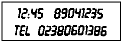

the second unit 2 held by an attendant at the hire company is in a standby state; and

both real time clocks 34,72 are generally synchronised.

1. A person who wishes to use the vehicle (the “driver”) calls the displayed telephone number (unless of course they are already at the hire company's premises), negotiates with the hire company attendant the rental of the vehicle for a predetermined period, say one day, and pays whatever charge is due, for example by credit card.

2. The driver then reads the seal number A₁ which is displayed by the display 60 and tells it to the hire company attendant.

3. The hire company attendant then activates the second subsystem 2 using the i-Button as a result of which the microcontroller 62 causes the display 78 to display an initial message such as:

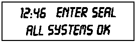

4. The hire company attendant then enters the seal number A₁ they have been told into the keypad 80. As the digits of the seal number are entered, they are displayed on the display 78. An incorrectly entered digit can be deleted by pressing the [symbol] key, and once all eight digits have been entered, the hire company attendant is required to press the [symbol] key.

5. The microcontroller 62 then reads the current time T₁ from the real time clock 72 and applies the predetermined first algorithm (as described in relation to the first embodiment) to the seal number A₁ and the time T₁ in order to generate an eight-digit number B₁ (the “release number”) which the microprocessor 62 causes to be displayed on the display 78, e.g. as:

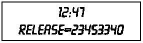

6. The hire company attendant then reads the displayed release number B₁ and tells it to the driver.

7. After a predetermined time, such as one minute, the second unit returns to its standby state.

8. The driver then enters the release number B₁ they have been told into the keypad 62 of the first subsystem 100. As the digits of the release number are entered, they are displayed on the display 60. An incorrectly entered digit can be deleted by pressing the [symbol] key, and once all eight digits have been entered, the driver is required to press the [symbol] key.

9. The microcontroller 26 then reads the current time T₂ from the real time clock 34, reads the seal number A₁ stored in the EEPROM 32, and applies the predetermined second algorithm (as described in relation to the first embodiment) to the seal number A₁, the time T₂ and the release number B₁ entered into the keypad 62 to determine whether the seal number A₁ and the release number B₁ correspond.

9.1. If they do not correspond:

9.1.1. The microcontroller 26 causes the display 60 to display an error message such as:

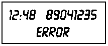

for a predetermined time and does not activate the relay 102 so that the vehicle remains immobilised.

9.1.2. The microcontroller 26 then causes the display 60 to revert to displaying the seal number A₁ and then waits for a further release number to be entered into the keypad 62 in step “8” above.

9.2. On the other hand, if the seal number A₁, time T₂ and release number B₁ do correspond:

9.2.1. The microcontroller 26 causes a 24-hour countdown timer to commence running to track the time remaining H of the hire period.

9.2.2. The microcontroller 26 supplies an enabling signal to the relay 102, so that the vehicle can be started.

9.2.3. The microcontroller 26 causes the display 60 to display a message including the time remaining H, such as:

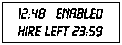

9.2.4. The microcontroller 26 then monitors the time remaining H, and when it reaches zero:

9.2.4.1. The microcontroller 26 terminates the enabling signal to the relay 102 so that the vehicle can no longer be started.

9.2.4.2. The microcontroller 26 generates a further pseudo-random eight-digit seal number A₂ which is also stored in the EEPROM 26 to replace the stored seal number A₁.

9.2.4.3. The subsystem 100 then reverts to the initial state described above, but now with the display 60 displaying the new seal number A₂, e.g.:

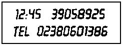

It will be appreciated from the above that the second embodiment of the invention permits the vehicle to be enabled for a predetermined period of time and that the vehicle is then disabled until the appropriate release number is entered into the keypad 62.

The second embodiment of the invention is applicable not only to hire vehicles and plant, but also to any other property that can be electrically enabled and disabled.

The modifications and developments described above in relation to the first embodiment of the invention may also be applied to the second embodiment of the invention. Furthermore, other modifications and developments may be made to the second embodiment of the invention. For example, the number of digits in the release number Bᵢ may be increased so that the period of time for which the subsystem 100 is to be enabled can be hidden in the release number. Then, when the release number is entered into the keypad 62, the microcontroller extracts that period from the entered number and sets the initial value of the countdown timer accordingly, and the remainder of the entered number is used in the second algorithm to determine whether the entered number is valid.

It should be noted that the embodiments of the invention have been described above purely by way of example and that many other modifications and developments may be made thereto within the scope of the present invention.

1. A locking system comprising first and second subsystems (1,2), wherein:
the first subsystem (1) comprises:
means (26) for generating a sequence of lock codes;
means (32) for storing the current lock code; and
means (60) for outputting the current lock code;
the second subsystem (2) comprises:
means (80) for receiving the lock code output by the first subsystem;
means (72) for generating a first real-time clock signal;
means (62) for applying a predetermined code-transforming algorithm to the received lock code and the first real-time clock signal to produce a release code; and
means (78) for outputting the release code; and
the first subsystem further comprises:
means (62) for receiving the release code output by the second subsystem;
means (34) for generating a second real-time clock signal;
means (26) for applying a predetermined correspondence-checking algorithm to the stored lock code, the received release code and the second real-time clock signal to produce a result; and
means (50) for selectably providing an unlocking signal in dependence upon the result.

2. The first subsystem per se of a system as claimed in claim 1.

3. A system or first subsystem as claimed in claim 1 or 2, wherein the code generating means is operable to generate such lock codes randomly or pseudo-randomly.

4. A system or first subsystem as claimed in any preceding claim, wherein the generating means is operable to generate such a sequence of lock codes while the first subsystem is operating.

5. A system or first subsystem as claimed in any preceding claim, wherein:
means (16,40) is provided for detecting a particular event;
the sequence generating means is operable to generate the next lock code in the sequence in response to detection of the particular event; and
the storing means is operable to store said next lock code in place of the said current lock code in response to detection of the particular event.

6. A system or first subsystem as claimed in any preceding claim, wherein, following the provision of the unlocking signal, the code generating means is operable to generate the next lock code in the sequence.

7. A system or first subsystem as claimed in claim 6, further comprising a sensor (18), and wherein the code generating means is operable to generate the next lock code in the sequence in response to a signal from the sensor.

8. A system or first subsystem as claimed in claim 6, wherein the code generating means is operable to generate the next lock code in the sequence a predetermined time after the provision of the unlocking signal.

9. A system or first subsystem as claimed in any preceding claim, wherein the means for providing the unlocking signal is operable to provide that signal for a, or the, predetermined time.

10. A system or first subsystem as claimed in any preceding claim, further comprising a lock (20) responsive to the unlocking signal.

11. A system or first subsystem as claimed in any preceding claim, further comprising a vehicle or machine that is enabled by the unlocking signal.

12. The second subsystem per se of a system as claimed in claim 1.

13. A system or subsystem as claimed in any preceding claim, wherein the code-transforming algorithm and/or correspondence-checking algorithm employ(s) information stored in a respective copy-resistant storage means (64,28) in the respective subsystem.

14. A system or subsystem as claimed in any preceding claim, wherein the, or at least one of the, outputting means comprises a display (60,78) for displaying the respective code to a user.

15. A system or subsystem as claimed in any preceding claim, wherein the, or at least one of the, receiving means comprises a keypad (62,80) to permit a user to enter the respective code.
